(19) United States
(12) Patent Application Publication
(10) Pub. No.: US 2016/0167642 A1
(43) Pub. Date: Jun. 16, 2016

(54) METHOD FOR OPTIMISING THE ENERGY CONSUMPTION OF A HYBRID VEHICLE

(71) Applicant: RENAULT S.A.S, Boulogne-Billancourt (FR)

(72) Inventor: Maxime DEBERT, Versailles (FR)

(73) Assignee: RENAULT s.a.s., Boulogne-Billancourt (FR)

(21) Appl. No.: 14/888,474

(22) PCT Filed: Apr. 11, 2014
(86) PCT No.: PCT/FR2014/050890

§ 371 Date: Jan. 28, 2016

(30) Foreign Application Priority Data
May 3, 2013 (FR) 1354089

(51) Int. Cl. B60W 20/15; B60W 30/188; B60W 10/26; B60W 10/06; B60W 10/08

(52) U.S. Cl. CPC B60W 20/15; B60W 10/06; B60W 10/08; B60W 10/26; B60W 30/188; B60W 2540/30; B60W 2550/20; B60W 2550/402; B60W 2710/0677; B60W 2710/086; B60W 2710/248; Y10S 903/93

(57) ABSTRACT

A method optimizes the energy consumption of a hybrid vehicle on a route as a function of the energy management rules of the vehicle, the charge state of the traction batteries of the vehicle, and the anticipated route. The method includes splitting between the supply of torque of thermal origin and the supply of torque of electrical origin over the route based on a prediction of the total energy consumption for the route, established as a function of an estimate of the consumption and of the energy split between these two sources over different sections making up the anticipated route.

The present invention relates to the domain of energy management in hybrid vehicles having at least one source of thermal energy and one source of electrical energy.

More specifically, it relates to a method for optimizing the energy consumption of a hybrid vehicle on a route as a function of the energy management rules of said vehicle, the charge state of the traction batteries of same, and the anticipated route.

This invention is preferably but not exclusively intended for rechargeable hybrid vehicles in which the traction batteries can be recharged directly from a power outlet on the electricity network.

A common energy management method in a rechargeable hybrid vehicle involves initially preferring the electrical discharge of the batteries, and subsequently maintaining the charge state of same once the battery charge is low. This method is usually incompatible with the objective of reducing energy expenses and protecting the environment. Depending on the distance and the profile of the anticipated route, it may be more advantageous to drive in hybrid mode, even if that means reaching the destination with the batteries discharged.

To enable the judicious use of the energy resources (electric and thermal) of the vehicle, the energy management system of the vehicle needs to know the energy requirement of the vehicle and the quantity of recoverable energy on the anticipated trip. This requirement depends on a large number of parameters, such as driving style, environment (urban, freeway, elevation), as well as various disturbances, related to the vehicle (load) or external (rain, wind, traffic density, etc.).

The publication US 2010/0305839 discloses an energy-prediction method based on consumption models for vehicles as a function of traffic conditions. This method does not take account of the peculiarities of each driver. Consequently, it is unlikely to be compatible with an onboard energy management system.

The present invention is intended to predict the energy category of the sections travelled by a vehicle on a given route, in order to optimize use of the energy resources of same as a function of the peculiarities of the vehicle and of the route.

For this purpose, it proposes that the split between the supply of torque of thermal origin and the supply of torque of electrical origin over the route be based on a prediction of the total energy consumption for the route, established as a function of an estimate of the consumption and of the energy split between these two sources over different sections making up this route.

Preferably, the route is broken down into sections in a database populated with an estimate of the energy category of each section.

The present invention is further explained in the description below of a nonlimiting embodiment of same, provided with reference to the attached drawings, in which:

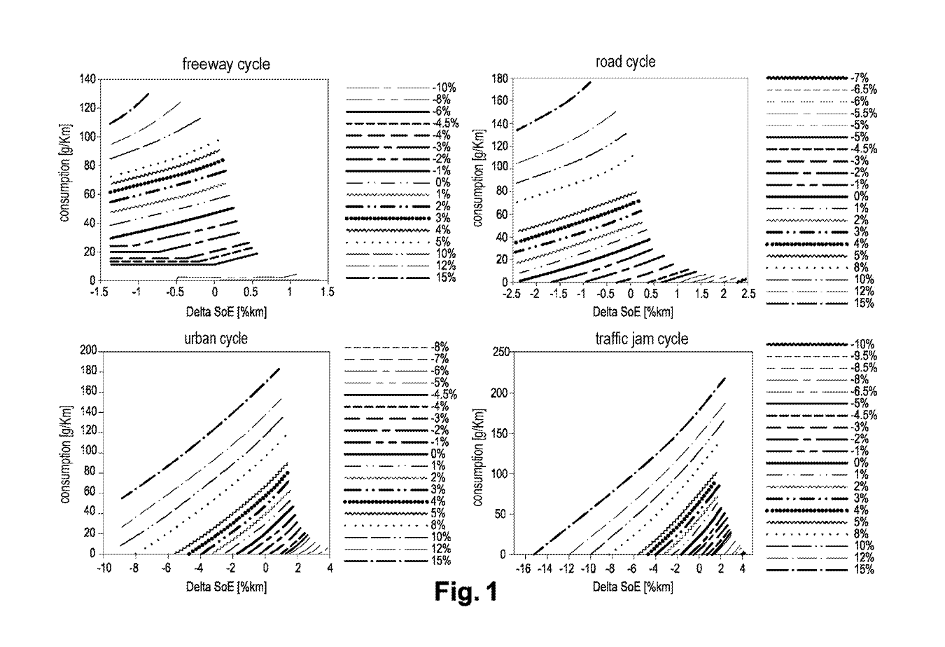

FIG. 1 shows a family of curves showing fuel consumption as a function of the percentage of electrical energy used to travel one kilometer, the average incline of the section, and the energy category of the section,

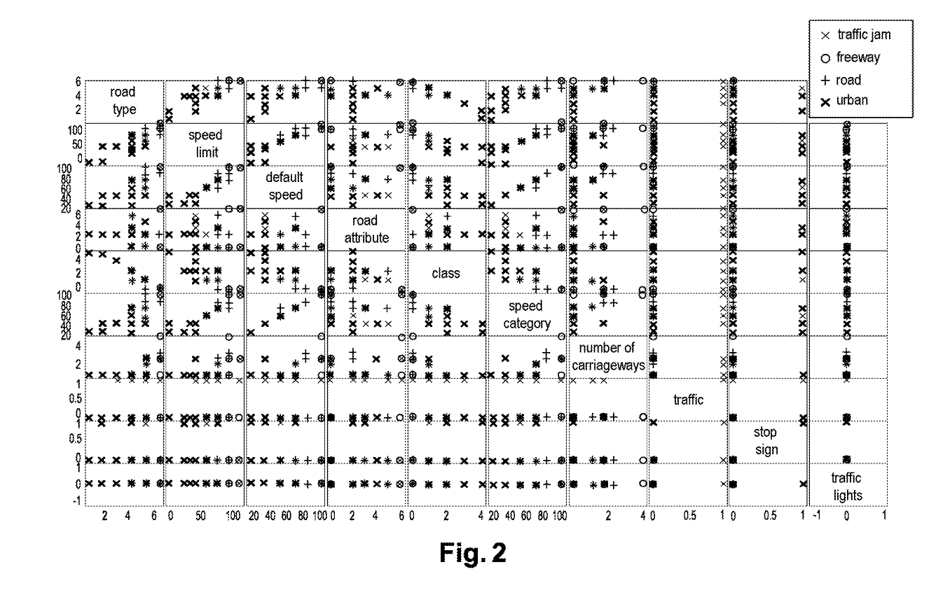

FIG. 2 shows the classification of the road sections in the database used,

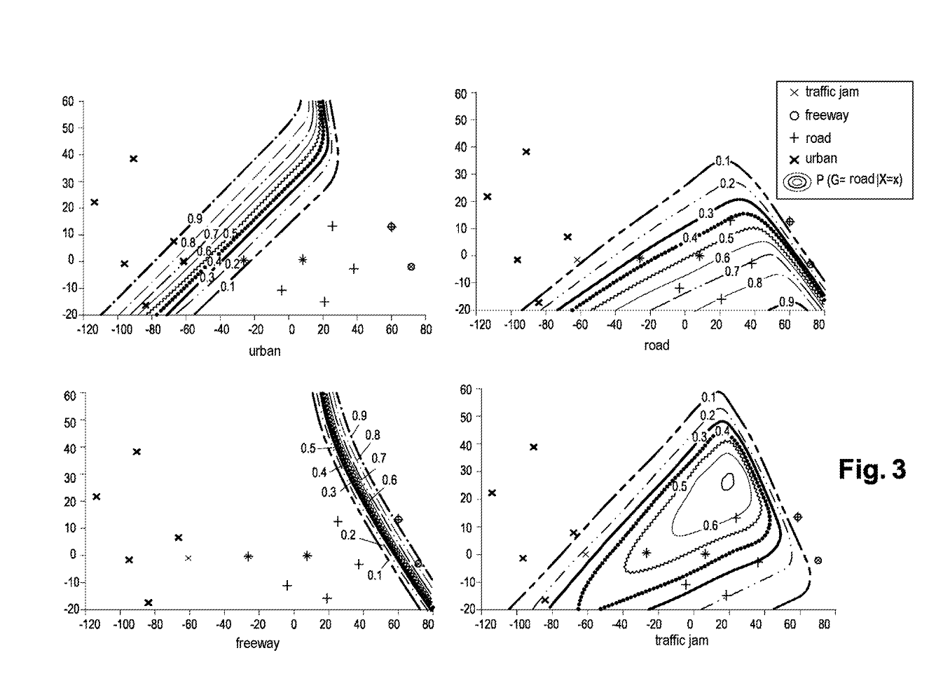

FIG. 3 shows the results of a “logistic regression” on four energy categories of sections, and

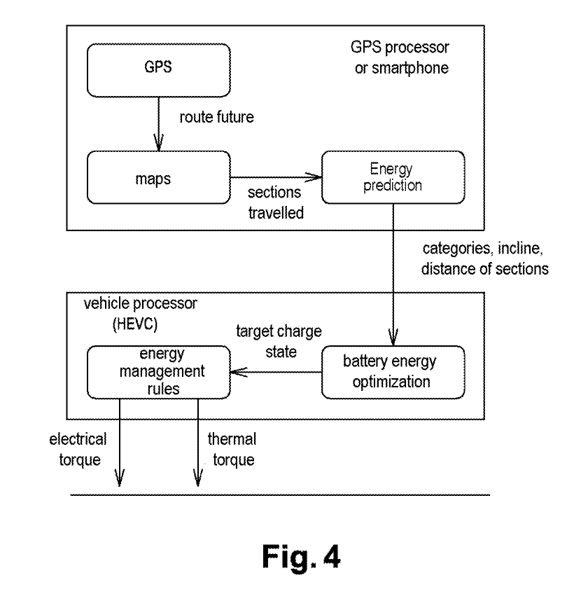

FIG. 4 summarizes the optimization method.

The invention proposes using the consumption curves of a hybrid vehicle as a function of the percentage of electrical energy used. FIG. 1 combines, by way of example and for the purpose of comparison, a family of consumption curves for a given hybrid vehicle on a freeway cycle, a road cycle, an urban cycle and in a traffic jam, to travel 1 km with different average gradients.

The invention uses an onboard navigation system in the vehicle that is able to indicate the position and route of the vehicle at all times. The system also provides information on the sections of the route, such as average speed, number of carriageways, traffic lights, signs, etc., enabling same to calculate the shortest, quickest and—most importantly—most beneficial route in terms of energy management. To do so, the method proposed is based on the use of a specific cartographic database by the navigation system.

This database is set up using existing cartographic data, listing a sufficient number of routes to establish a prediction model. A directory makes it possible to classify the road sections provided by the map provider: a section usually corresponds to a road segment having identical characteristics. Sections may be several meters to several kilometers long. They are classified as a function of the optimal split over a given distance found by an optimization algorithm using a calculation model based on the fundamental principle of dynamics, on the basis of route information given by vehicles, in particular the speeds and inclines recorded. This information also includes a family of curves such as those in FIG. 1, showing fuel consumption as a function of the percentage of electrical energy used to travel one kilometer, for four different section categories.

The sections are therefore classified into energy categories, depending on the shape of the consumption curve as a function of the percentage of electrical energy used. Correlation functions may for example be used to characterize the shape.

The energy consumption of a hybrid vehicle is optimized over the whole of a route as a function of the energy management rules of said vehicle, the charge state of the traction batteries of same, and the anticipated route. To do so, an algorithm of the navigation system calculates an optimal energy split between thermal and electrical sources over the entire anticipated trip to predict the energy requirements of the vehicle on same. The prediction involves estimating the energy category of the sections that the vehicle will travel using the populated database. This requirement for example classifies the anticipated route into one of the aforementioned four categories: traffic jam, urban, road and freeway.

The database is advantageously built by recording the global positioning system (GPS) position and speed of test vehicles. Each test route is then broken down into sections in the database, which is populated with an estimate of the energy consumption of the vehicle over each section. Using the GPS coordinates and the sections travelled, certain characteristics of these latter are also noted. The optimization algorithm is then able to determine the optimal energy split for each section, minimizing driving costs. As indicated above, the sections are classified as a function of the shape of the curve of same that is closest to one of the established categories, for example the four categories cited (traffic jam, urban, road and freeway).

The structure of the database is shown in FIG. 2 in the form of clouds of matrix points, without being limited to same. In this example, the sections are classified as a function of ten characteristic data:
section type (from six categories),
maximum permitted speed on the section,
average actual speed, updated with traffic information (default speed),
road “attributes”: presence of roundabouts or bridges, urban, intersection, etc.,
section “class” (providing information on the maximum flow rate),
a reference speed (“speed category”),
number of carriageways (in the direction of travel),
traffic (presence or absence of slow traffic, updated using traffic information),
presence of stop signs,
presence of traffic lights.

This example shows that all of the variables are relevant when selecting the energy categories. For example, a high legal speed limit shows a good correlation with the freeway and road categories. It may be complemented by journeys made by the client if they so wish (recording of client trips).

The invention provides for the implementation, using this data, of a statistical model used to predict the energy class of the route. This model is advantageously built using the “logistic regression” technique used in numerous fields, such as medicine and banking. However, other classification/sorting methods may be viable (such as decision trees, neural networks, etc.) and used to implement the invention.

The logistic regression model can for example take the following form:

$$log \frac{Pr ( G = 1 \vert X = x )}{Pr ( G = K \vert X = x )} = {β}_{10} + {β}_{1}^{T} x$$

$$log \frac{Pr ( G = 2 \vert X = x )}{Pr ( G = K \vert X = x )} = {β}_{20} + {β}_{2}^{T} x$$

$$⋮$$

$$log \frac{Pr ( G = K - 1 \vert X = x )}{Pr ( G = K \vert X = x )} = {β}_{( k - 1 ) 0} + {β}_{K - 1}^{T} x$$

The model is specified in K−1 logarithmic function, reflecting the condition that the sum of probabilities must be equal to 1. A simple calculation gives the following:

$$Pr ( G = k \vert X = x ) = \frac{{e}^{( {β}_{k 0} + {β}_{k}^{T} x )}}{1 + {}_{l = 1}^{K - 1}{Σe}{}_{}^{( {β}_{10} + {β}_{l}^{T} x ) )}}$$

$$Pr ( G = K \vert X = x ) = \frac{1}{1 + {}_{l = 1}^{K - 1}{Σe}{}_{}^{( {β}_{10} + {β}_{l}^{T} x ) )}}$$

The estimate of the logistic regression model is provided notably by the maximum likelihood method popularized by the statistician and biologist R. A. Fisher. Since Pr (G|x) satisfies the distribution conditions, the log-likelihood function for N observations is written:

$$l ( β ) = {\sum }_{i = 1}^{N} log {P}_{gi} ( {x}_{i} ; β )$$

Once the optimization algorithm has identified the parameters of the model (equation 1) on the identification data, the validity of same must be checked on the validation data. FIG. 3 shows the results of the logistic regression for the four categories on the validation data. The unbroken lines represent the iso-probabilities of belonging to a given class. The section category predictions obtained using this method are 97% reliable.

In summary, the split between the supply of torque of thermal origin and the supply of torque of electrical origin over the route is based on a prediction of the total energy consumption of the route established as a function of an estimate of the consumption and of the energy split between these two sources over different sections making up this route. A database able to classify the sections and to predict the category of a route is required to implement the invention. This database can be continuously populated using data collected on moving vehicles, in order to feed a reliable energy prediction model. This model is preferably a “classifier” model, such as a logistic regression model. It is preferably carried on board a vehicle in a navigation system, enabling it to send the probabilities of future energy requirements to the processor carrying out the energy optimization. The database can also be updated by learning about the driver using the vehicle, with a view to optimizing the strategy for said driver.

As shown in FIG. 4, the onboard GPS processor or a “smartphone” mobile communication tool is able to establish a route future by breaking down same into sections travelled to predict the energy consumption for the trip. The “route category” datum is then used in a processor in the vehicle (HEVC) to determine the split between the supply of electrical and thermal energy on the trip.

With other information, incline and section lengths, this latter is able to apply the energy management rules (LGE) of the vehicle, the quantity of electrical energy to be used on the sections to minimize the consumption of the vehicle and to optimize the energy stored in the batteries of the vehicle. Preferably, the discharge curve of the battery on the route minimizes the total energy consumption of the vehicle.

The advantages the invention are numerous, and include:
the option of adapting the energy prediction to the driver and to the driving style of the driver, using the learning option,
reduced consumption in rechargeable hybrid vehicles, and
the option of supplying electrical energy in urban areas restricted to “zero emission” vehicles.

Finally, it should be noted that the invention applies primarily to motorcars, but multiple supports may be used to implement the invention (“smartphone”, tablet, off-board navigation processor, portable GPS, infrastructure processor, etc.).

1-9. (canceled)

10. A method for optimizing energy consumption of a hybrid vehicle on a route as a function of energy management piles of said vehicle, a charge state of traction batteries of the vehicle, and an anticipated route, comprising:
splitting between a supply of torque of thermal origin and a supply of torque of electrical origin over the route based on a prediction of a total energy consumption for the route, established as a function of an estimate of the consumption and of the energy split between these two sources over different sections making up the anticipated route.

11. The optimization method as claimed in claim 10, wherein the route is broken down into sections in a database populated with an estimate of an energy category of all of the sections.

12. The optimization method as claimed in claim 11, wherein the sections are classified as a function of different criteria, enabling an optimal split of the energy requirement on each one to be determined.

13. The optimization method as claimed in claim 12, wherein the sections are classified according to a shape of a consumption curve of same, as a function of the electrical energy used.

14. The optimization method as claimed in claim 13, wherein the sections are classified into four categories, including freeway, road, urban, and traffic jam, as a function of the shape of the consumption curve of same.

15. The optimization method as claimed in claim 10, wherein the aggregate of the sections and a statistical model are used to determine an energy category to which the route belongs, thereby enabling prediction of the energy requirements of the vehicle on said route.

16. The optimization method as claimed in claim 15, wherein the category of the route is used in a processor in the vehicle to determine the split between electrical and thermal energy on the trip.

17. The optimization method as claimed in claim 14, wherein a discharge curve of the battery on the route minimizes the total energy consumption of the vehicle.

18. The optimization method as claimed in claim 11, wherein the database is updated by learning about a driver of the vehicle.
